(19) United States
(12) Patent Application Publication
(10) Pub. No.: US 2014/0012501 A1
(43) Pub. Date: Jan. 9, 2014

(54) DRIVER ASSISTANCE SYSTEM

(71) Applicant: GM GLOBAL TECHNOLOGY OPERATIONS LLC, Detroit, MI (US)

(72) Inventor: Uwe HAHNE, Buettelborn (DE)

(21) Appl. No.: 13/934,543

(22) Filed: Jul. 3, 2013

(30) Foreign Application Priority Data
Jul. 5, 2012 (DE) 102012013376.6

(51) Int. Cl. G01C 21/34

(52) U.S. Cl. CPC G01C 21/34
USPC 701/533

(57) ABSTRACT

Devices for supporting a driver with a route guidance system are provided. A device includes a system for route guidance in a road network along a current route R1 from a current position PF of the vehicle to a destination Z, a sensor for acquiring a vehicle environment and/or a sensor for acquiring a vehicle state, and an output means. The device further includes a means for determining a probability value W for departure from the current route R1 at an approaching position P of the current route R1 based on the current position PF of the vehicle, the current route R1, the acquired vehicle environment and/or the acquired vehicle state. The means also is configured for determining an alternative route R2 from position P to destination Z as a function of the probability value W and this position P and output it with the output means.

### CROSS-REFERENCE TO RELATED APPLICATION

This disclosure claims priority to German Patent Application No. 102012013376.6, filed Jul. 5, 2012, which is incorporated herein by reference in its entirety.

### TECHNICAL FIELD

The technical field relates to a device for supporting a driver with route guidance, a method for operating the device, as well as a vehicle that encompasses the device or in which the method is implemented.

### BACKGROUND

Route guidance systems have by now become widespread, and are either firmly implemented in vehicles or can be used as independent navigation systems. Route guidance systems are usually designed in such a way that, given a departure from the route leading to a destination, they attempt to route the vehicle back to the departure position, or to the next point of reentry into the selected route. As a rule, a new route to the destination is determined and taken as the basis for route guidance only if the currently traveled route clearly deviates from the route selected by the route guidance system. Therefore, such route guidance systems only react to a deviation from the selected route after the fact.

DE 10 2004 036 825 A1 suggests the option of alerting the driver when it becomes evident that he or she will deviate from the selected route.

At least one object herein is now to provide further improved route guidance systems. In addition, other objects, desirable features and characteristics will become apparent from the subsequent summary and detailed description, and the appended claims, taken in conjunction with the accompanying drawings and this background.

### SUMMARY

In an exemplary embodiment a device supports the driver of a vehicle with a system for route guidance in a road network along a current route R1 from a current position PF of the vehicle to a destination Z, a sensor for acquiring a vehicle environment and/or a sensor for acquiring the vehicle state, and an output means. A means is present with which it is possible to determine a probability value W for departure from the current route R1 at an approaching position P of the current route R1 based on the current position PF of the vehicle, the current route R1, the acquired vehicle environment and/or the acquired vehicle state, as well as to determine at least one alternative route R2 from position P to destination Z as a function of the probability value W and this position P, and output it with the output means. As a consequence, the device is designed to determine how a trip will continue in the immediate future based on the vehicle environment and/or vehicle state, for example the traveling speed, change in traveling speed, traveling direction or an activated or non-activated blinker, and whether a high probability, expressed by a high probability value W, of departure from the current route R1 exists based on this prediction. The expert is familiar with the implementation of such predictions, which has been described in DE 10 2004 036 825 A1, for example.

For example, the system for route guidance in a road network can be a navigation system, which is either built into the vehicle or comes into contact with the vehicle as a self-contained, external device. When the driver selects a destination Z, the route guidance system determines a current route R1 or offers the driver several alternative routes, from which he or she then selects a route that is taken as the basis for the current route R1.

The current position PF can be determined in various ways known to the expert, for example via geoposition data that stems from corresponding satellite navigation systems, like the global positioning system (GPS), Galileo, the Russian GLONASS or similar systems. In special further developments, the position PF is determined by the route guidance system. Additional, non-limiting options for further development include means for identifying road or traffic signs or objects such as buildings, to which geoposition data can then be allocated. For example, sensors for acquiring a vehicle environment can correspondingly perform multiple functions in the device if used to acquire the vehicle environment and additionally localize the vehicle itself.

The means for determining a probability value W can be any means suitable for processing data to be considered for the device, such as the current position PF, current route R12, data collected by the sensor for acquiring a vehicle environment, and data collected by the sensor for acquiring a vehicle state, for example electronics with logic circuits, such as a printed circuit board. In particular, the means can take the form of a central vehicle computer, with which other vehicle functions can then also be controlled.

The means for determining a probability value W now processes the current position PF, which of course constantly changes while the vehicle is in motion, the vehicle state and/or the vehicle environment or the data collected by the corresponding sensors with respect to the vehicle state and/or vehicle environment. This processing makes it possible to predict how the vehicle will continue to move in the immediate future. For example, if a sensor for acquiring a vehicle state registers a turning of the steering wheel, the vehicle will be cornering, but not traveling straight ahead, for the time the steering wheel is turned, presuming a secure traction for the tires. For example, if a sensor for acquiring a vehicle environment registers that, out of several lanes, the vehicle is in a turn lane, it can be assumed that cornering will also take place. By comparing a presumed route predicted in this way with the actually provided current route R1, the device can determine a probability value W that furnishes information as to the probability of departure from the current route R1. In addition, an approaching position P can be determined at which departure from the route is expected. In particular, comparing the predicted, assumed routes with data about a road network that are available to the route guidance system makes it possible to determine position P, wherein it is generally first assumed that the vehicle does not exit the road network at irregular locations. An alternative route R2 can be determined and output with a high probability value W with the device, preferably by means of its route guidance system.

In an exemplary embodiment, the probability values W depend on the current position PF, the acquired vehicle environment and/or the acquired vehicle state, or on the quality of the data acquired in this conjunction. For example, the quality of the data relative to the current position PF may depend on how many navigation satellites are accessible to the route guidance system at the time for determining the position. Given a few accessible satellites, for example when in high urban canyons, errors are more likely to be made when determining the position PF, so that presumed deviations from a current route R1 preferably do not yield a high probability value W, or do so less quickly than when better satellite data are available. In another example, slight turns of a steering wheel are a less reliable indication of cornering than strong turns of a steering wheel, so that the former are as a rule less reliable in indicating a departure from a current route R1, since they might also reflect normal irregularities in the steering behavior of the driver or reactions to bumps on the road. Such considerations are familiar to the expert in light of the disclosure made herein, and can be taken into account when determining probability values W.

As a consequence, the device makes it possible to alert the driver to the risk of departure from the current route R1 advantageously already prior to any actual departure from the current route R1, but also to the consequences of such a departure, since the output of at least one alternative route R2 allows the driver to immediately discern the alternative route R2 with which the output of the current route R1 is linked. This is useful in particular when drivers do not strictly follow the current route guidance R1, since they can rely on the route guidance system to as a rule always offer an alternative route after a certain period of time. However, alternative routes are often associated with more driving effort, which is why the current route guidance was originally also taken as the basis. The output of an alternative route R2 even before departing from the current route R1 can better show the advantages of the current route R1 to the driver, and encourage him or her to more consistently maintain this route R1.

In an embodiment, the alternative route is output by means of output means customary in prior art, in particular acoustic means, such as loudspeakers, or visual means, such as screens or heads-up displays. For example, an acoustic output can take the form of a route description, for example via announcements like “You are about to leave the current route, which will present you with a detour of 15 km”. The output takes place at least visually, in particular via chart displays customary in prior art, and/or messages such as the exemplary message above in written form.

A further embodiment of the device provides that the output means display the current route R1 and new route R2 simultaneously, thus allowing the driver to make a direct comparison. For example, the current route R1 and alternative route R2 or alternative routes R2 can be represented in different ways, e.g., in various colors, so as to highlight the difference to the driver.

In an embodiment, the means is designed and set up to determine a driving time to destination Z, a driving distance to destination Z and/or a required fuel consumption for the at least one alternative route R2 in relation to using the current route R1, and output the latter with the output means. As a consequence, the driver can advantageously use concise data to quickly contrast the pluses and minuses of routes R1 and R2, and still reach a timely selection between these routes before arriving at position P. For example, if it turns out that the alternative route R2 would require twice the driving time or twice the driving distance to the destination, or several more liters of fuel consumption by comparison with the current route R1, the driver has a strong criterion at his or her disposal for deciding between the routes.

In an embodiment, the approaching position P is a turnoff, which when taken must result in a departure from the current route R1, and which lies a distance ranging from 10 m to 1000 m or 50 m to 500 m or 50 m to 300 m ahead of the current position PF of the vehicle on the current route R1. Examples for such positions P are highway exits that as a rule are signaled about 1000 m (meters) in advance for the first time, and about 500 m in advance for the second time, before a deceleration lane 300 m in advance actually provides the chance to exit the traveled highway. Once a vehicle has left a highway in the deceleration lane, it is inevitably led away from the highway, and this decision can only be reversed with difficulty by driving back onto a highway entrance ramp. Additional non-limiting examples include highway entrance ramps, federal highways or expressways, which as a rule offer comparatively few on or off ramps, bridge entrance ramps, tunnel portals, or entrances into one-way streets, parking garages, underground garages, or regions provided with entry gates. The ability provided by the device of consciously selecting between remaining on or leaving the current route R1 even before reaching position P can hence prove very advantageous as travel continues.

In an embodiment, a means for determining the approaching position P can be linked with a navigation database, for example a database present in the vehicle or a wirelessly accessible database external to the vehicle. In special configurations, such means and/or the navigation database comprise part of the route guidance system in a road network. As a consequence, corresponding positions P can advantageously be ascertained for which probability values W can assume a high figure. Non-limiting examples for such positions P include in particular those positions that belong to two possible routes at the same time, such as T-junctions, crossings, highway exits in those areas where a change is permitted between the highway and deceleration lane, or entrances in specific areas like parking zones or exits from the latter. Other non-limiting examples include positions in which a slight future deviation from the position PF of the vehicle has a crucial influence on the future route, e.g., multilane roadways, in particular in the area of crossings. For example, getting into a wrong turn lane may force the driver to follow an undesired route, since lane markings or traffic density often make it impossible to change after the fact. Connecting the means for determining the approaching position in particular with navigation databases that store properties of such positions P makes it possible to detect problematic positions in advance, and possibly output an alternative route R2 if the probability value W points to a departure from the current route R1.

The expert is familiar with a plurality of sensors for acquiring a vehicle environment, which can also be used for the device according to an embodiment. In special embodiments of the device, the sensors can be selected from among optical sensors, radar sensors, ultrasonic sensors and LIDAR sensors. One or more sensors can here be used within the framework of the device, and when several sensors are used, they can be the same or different. For example, optical sensors can be used to detect traffic signs, lane markings or directional markings applied to roadways, such as in turn or straight lanes, while radar, ultrasonic or LIDAR sensors can be used to detect tunnel portals, reflector posts or guardrails, whose absence at certain locations points to roadway exits. All of this information, which is only exemplarily and by no means exhaustively described here, can be used as the basis for determining the vehicle environment and drawing inferences about available travel routes and likely selected travel routes. For example, a traffic sign or roadway arrow denoting that the vehicle is currently in a mandatory right turnoff lane would trigger a high probability value for departure from the current route if the latter provides for straightaway travel. Also detectable are vehicles in the environment, wherein in particular the position and positional change of the vehicles ahead can be used to draw inferences as to routes that are available and probably traveled by one's own vehicle. For example, if one's own vehicle is situated almost in the middle behind two vehicles traveling next to each other, but slightly more behind the vehicle on the right that is just heading into a right-hand bend, while the vehicle on the left continues on straight, there is a higher probability that one's own vehicle will end up also headed into a right-hand bend. If the current route R1 actually provides for straight ahead travel or at least no right-hand bend, a high probability value W for departure from the current route R1 at an immediately approaching position P, as denoted by the vehicle ahead that is driving to the right, triggers the determination and output of an alternative route R2, which assumes the position P as the starting point. As a consequence, the driver can immediately recognize the ramifications for route guidance in cases where he or she actually deviates from route R1 by heading into a right-hand turn.

The expert is further familiar with a plurality of sensors for acquiring a vehicle state, which can also be used for the device according to an embodiment. In special embodiments of the device, the sensors can be selected from among position sensors, such as sensors for acquiring data from satellite navigation systems, speed sensors, acceleration sensors, gas pedal position sensors, brake pedal position sensors, turn signal sensors and steering angle sensors. Information provided by these sensors is also suitable for predicting the probability of departure from the current route R1. For example, if acceleration sensors signal a strong acceleration of one's own vehicle, while the current route provides for a left-hand turn after 50 m, there is a high probability value that the location after 50 m is an approaching position P at which the current route R1 will be departed, which in turn triggers the determination and output of an alternative route R2 starting at position P. The gas pedal and brake pedal position sensors provide information in a corresponding manner, wherein a failure to brake or an ensuing acceleration does not point to an actually planned turn at a fast approaching position P, and vice versa. Similarly, activated turn signals or measured turns of the steering wheel provide an indication of impending or already initiated cornering, which points to a directional change that then triggers a high probability for departure from a current route R1 if this current route R1 actually provides for straightaway travel, and vice versa.

Armed with knowledge about the inventive idea disclosed here and the exemplary options for evaluation mentioned above for the data acquired by various sensors, the expert can easily derive additional options for evaluation or determine which sensors or sensor combinations can be used within the framework of the device according to the embodiments herein.

Provided in addition to the outputable alternative route R2 is the optional presence of a warning device, which can be used to output a warning depending on the ascertained probability value W for departure from the current route R1 and distance between the current vehicle position PF and the approaching position P. In particular, the distance can play a role if it is large enough to allow the driver to correct his or her impending departure from the current route R1. In this case, a warning makes sense. By contrast, if the distance or available time until reaching position P is too short for the driver to react without endangering his or her own person or other road users, in an embodiment the warning is omitted so as not to trigger a risky driving maneuver by the driver. The warning device can be any device with which an acoustic, optical and/or haptic signal can be output, for example. For example, the driver can be additionally alerted by a warning sound, warning light or vibrating steering wheel, driver's seat and/or gearshift lever to the likely impending departure from the current route R1, so as to advantageously further enhance his or her attentiveness in this regard.

Further embodiments provide that different warnings can be output depending on the distance between the current vehicle position and approaching position P. The warnings can preferably become more intensive as position P gets closer and closer. For example, acoustic warnings can be output with an increasingly higher volume or increasingly distinctly perceived frequency, or optical blinking signals with increasing brightness or blinking frequency. Another conceivable example would be alternating colors that symbolize warnings, for example a green signal denoting a maximum distance from position Pat which departure can still be easily averted, a yellow signal with increasing proximity to position P, at which a correction of traveling direction is urgently recommended, and a red signal for cases where position P is already so close that a safe correction no longer appears possible.

Other embodiments provide that the alternative route can be determined according to set criteria as the shortest, fastest or most economical route. The corresponding criteria can be preset by the driver as a variable basic setting or respectively modified as needed. The device optionally provides at least one input means that the driver can use for this purpose, for example keyboards, display keyboards on touch screens, joysticks, knobs, voice inputs or other input means known in the trade.

Another embodiment relates to a vehicle, in particular a motor vehicle that encompasses a device as contemplated herein. The device can here be firmly integrated into the vehicle. As an alternative, it can be present as a separate module that can be connected with the vehicle, for example comparably to mobile navigation devices. Access to data from sensors for acquiring the vehicle environment and/or sensors for acquiring the vehicle state can be gained by accessing a central computer in the vehicle. Such vehicle computers are as a rule present in the latest vehicle models, centrally acquire data from such sensors during the regulation of vehicle dynamics or within the framework of various assistance systems, and can hence also make them available for a device as contemplated herein.

Another embodiment relates to a method for supporting the driver of a vehicle with a system for route guidance in a road network along a current route R1 from a current position PF of the vehicle to a destination Z, a sensor for acquiring a vehicle environment and/or a sensor for acquiring a vehicle state, and an output means, wherein the method encompasses the following steps:

The current position PF of the vehicle, the current route R1, the vehicle environment and/or the vehicle state are acquired. Based on this current position PF, the current route R1, the vehicle environment and/or vehicle state, a probability value W is determined for departure from the current route R1 at an approaching position P of the current route R1. Depending on the probability value W, at least one alternative route R2 from position P to destination Z is determined, and the alternative route R2 is output by the output means.

The method is especially suitable for controlling a device according to the invention. Accordingly, reference is made to the procedural steps implicitly disclosed above within the framework of the device.

Embodiments of the method provide that a travel time to the destination and/or a fuel consumption in relation to using the current route R1 be determined and output for the at least one alternative route R2.

General further embodiments of the method allow driver inputs, for example to select preferred options. Non-limiting examples include the specified choice between the preferred output of travel time, route or fuel consumption for the alternative route R2 by comparison with the current route R1. Possible input means encompass the means indicated within the framework of the device, for example.

Another embodiment of the method provides that the approaching position P be a turnoff, which, if taken, inevitably leads to the departure from the current route R1, and lies at a distance ranging from 10 m to 1000 m, 50 m to 500 m, or 50 m to 300 m on the current route R1 ahead of the current position PF of the vehicle.

In particular the options discussed with respect to the various embodiments are possible for acquiring the current position PF of the vehicle, the vehicle environment and vehicle state, such as satellite navigation systems or corresponding sensors, such as optical sensors, radar sensors, ultrasonic sensors or LIDAR sensors along with position sensors, speed sensors, acceleration sensors, gas pedal position sensors, brake pedal position sensors, turn signal sensors or steering angle sensors.

The embodiments, configurations and further developments discussed within the framework of the method can also be analogously implemented within the framework of the method.

Accordingly, an embodiment provides that an approaching position P be determined via a connection with a navigation database within the framework of the method.

A further embodiment of the method provides that a warning be output depending on the determined probability value W for departure from the current route R1 and a distance between the current vehicle position PF and approaching position P, wherein reference is made to corresponding statements within the framework of the device. Accordingly, various warnings can be output as a function of the distance between the current vehicle position and approaching position P.

A further embodiment of the method provides that the alternative route can be determined according to presettable criteria as the shortest, fastest or most economical route. Accordingly, basic settings can be prescribed and taken as the basis for the method.

General further embodiments of the method provide for one or more additional optional procedural steps that allow driver inputs. Non-limiting examples for such inputs involve changing the basic settings mentioned above, determining whether to output one or more alternative routes R2, figuring out how to distinguish between several alternative routes R2, for example via color allocation, and deciding whether or how to output additional warnings to go along with the alternative route(s) R2, and the like.

The aforementioned embodiments and further developments of the method and the device contemplated herein, as well as individual features thereof, can be readily combined by the expert, and such combinations are contemplated herein.

### BRIEF DESCRIPTION OF THE DRAWINGS

The various embodiments will hereinafter be described in conjunction with the following drawing figures, wherein like numerals denote like elements, and wherein:

FIG. 1 is a simple block diagram of a device according to an exemplary embodiment;

FIG. 2 is an expanded block diagram of a device in a vehicle according to an embodiment;

FIG. 3 is a schematic illustration of a driving situation; and

FIG. 4 is a schematic flowchart of a method according to an exemplary embodiment.

### DETAILED DESCRIPTION

The following detailed description is merely exemplary in nature and is not intended to limit the various embodiments or the application and uses thereof. Furthermore, there is no intention to be bound by any theory presented in the preceding background or the following detailed description.

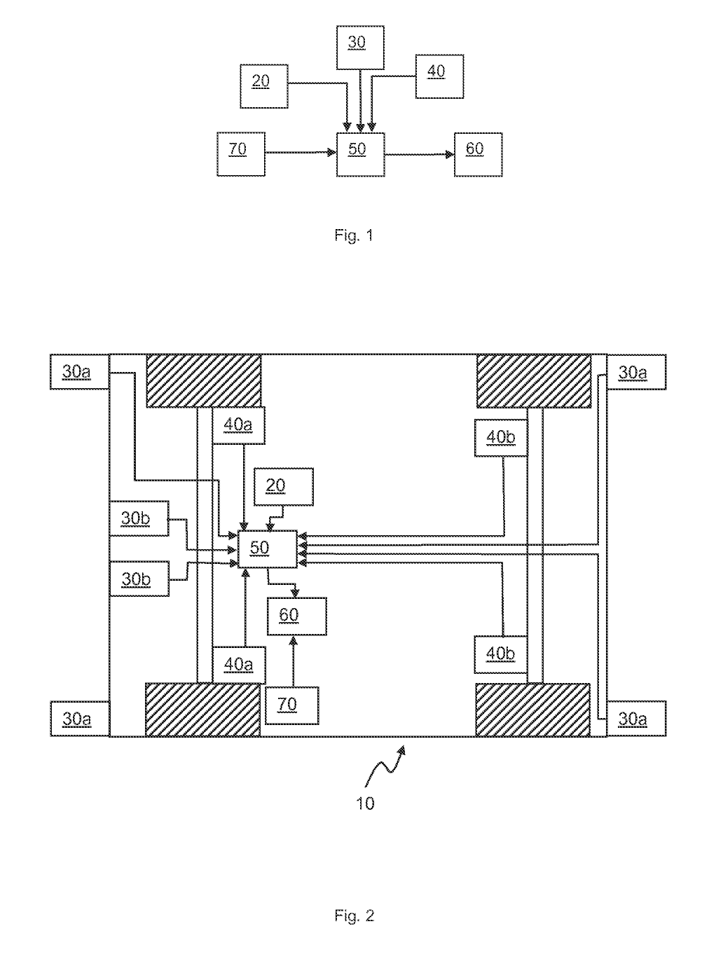

To provide an overview, FIG. 1 presents a block diagram that shows a device according to an embodiment encompassing a route guidance system 20, which establishes a current route R1 as the basis, and is suitable for determining the current position PF of a vehicle 10 (not shown). The device further encompasses at least one sensor 30 for acquiring a vehicle environment, which can also be suitable for determining the current position PF of the vehicle 10, and/or at least one sensor 40 for acquiring a vehicle state. The vehicle environment acquired by the sensor 30 and/or the vehicle state acquired by the sensor 40 or the data relating thereto are processed by means 50 for determining a probability value W. The current position PF, for example, is transmitted by the route guidance system 20 to the means 50. If processing yields a high probability value W for departure from the current route R1, the position P at which the current route R1 is likely to be departed from is simultaneously or subsequently determined, wherein the route guidance system 20 can be drawn upon. The position P is taken as the basis for the starting point or route point for determining an alternate route R2, which is displayed to the driver via the output means 60. As a result, the driver immediately sees the ramifications of a pending departure from the current route R1, and can prevent the departure if outweighed by the disadvantages of the alternative route R2.

In a schematic depiction that is by no means to scale, FIG. 2 shows a vehicle 10 encompassing several radar sensors 30a and optical sensors 30b for acquiring a vehicle environment. Steering angle sensors 40a and speed sensors 40b represent sensors 40 for acquiring the vehicle state. The mentioned sensors are only examples, wherein sensors can be discarded or additional sensors added. The above sensors transmit their data to a means 50 for determining a probability value W, which also receives data about the current route guidance R1 as well as the current position PF from a route guidance system 20. The means 50 can use sensors 30a, 30b, 40a and 40b to determine a probability value W for departure from the current route R1 at an approaching position P through reconciliation with the data provided by means 20. Given a sufficient probability value W, an alternative route R2 is determined and output via the output means 60. Driver inputs are possible by way of the input means 70.

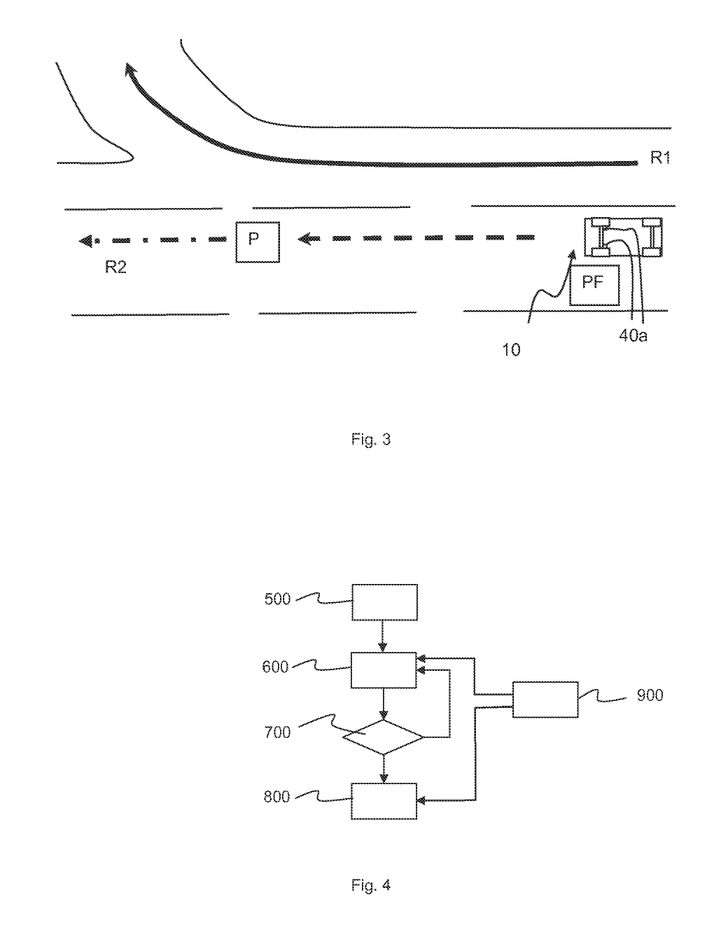

FIG. 3 presents a schematic driving situation. The current route R1 as symbolized by a solid arrow provides for a departure from the highway currently being traversed at the deceleration lane shown above. Steering angle sensors 40a reveal straightaway travel, even though the vehicle 10 is already at the level of the deceleration lane in view of the current position PF, and a right turn of the steering wheel should be registered. The probability value W for departure from the current route R1 is thus high. For this reason, an alternative route R2 that starts from the position P standing for a final departure from the current route R1 is calculated, which the vehicle 10 will likely reach after having traveled the route symbolized by a dashed arrow. The alternative route R2 is symbolized by a dash-dot arrow. An output means 60 (not shown for the sake of clarity) shows the driver the alternate route R2 to the destination Z also not depicted on FIG. 3, so that he or she is alerted to the impending departure from the current route R1, and still has an opportunity to weigh route R1 against route R2, and possibly continue along route R1.

FIG. 4 presents a simple schematic flowchart of a method according to an embodiment. A first procedural step 500 involves determining the current position PF of the vehicle, the vehicle environment and/or the vehicle state. Based on the determined current position PF of the vehicle, the determined current route R1, the determined vehicle environment and/or the determined vehicle state, a probability value W for departure from the current route R1 at an approaching position P of the current route R1 is ascertained in a second procedural step 600. In a third procedural step 700, an alternative route R2 from position P to destination Z is determined as a function of the ascertained probability value W. A corresponding determination is made at high probability values W, and omitted at low probability values W. In the latter case, there is no change whatsoever for the driver, since he or she follows the current route guidance, and also receives no information relating to an alternative route R2. However, if such an alternative route R2 is determined in view of a high probability value W, it is output in a fourth procedural step 800, for example with an output means 60. As a consequence, the driver is faced with a change, since the alternative route R2 is now shown to him/her, and this display already implies that his/her driving behavior points to a departure from the current route R1. In further developments, the method encompasses additional optional procedural steps 900, which allow driver input.

The current position PF of the vehicle as well as the current route R1 can be acquired in the first procedural step 500 in particular via the retrieval of corresponding data from the route guidance system 20 of a device according to an embodiment. The vehicle environment and/or the vehicle state can be acquired in particular by one or more sensors 30 for acquiring a vehicle environment and/or one or more sensors 40 for acquiring a vehicle state. The second procedural step 600 can be implemented in particular with a means 50 for determining a probability value, while the third procedural step 700 can be implemented in particular with a route guidance system 20. In particular the output means 60 of the device is suitable for outputting alternative routes R2 and possibly an additional warning, while inputs can be initiated via the input means 70 of the devices in the case of optional procedural steps 900.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1. A device for supporting a driver of a vehicle, the device comprising:
a system for route guidance in a road network along a current route R1 from a current position PF of the vehicle to a destination Z;
a sensor for acquiring a vehicle environment and/or a sensor for acquiring a vehicle state;
an output means, and
a means for determining probability value W for departure from the current route R1 at an approaching position P of the current route R1 based on the current position PF of the vehicle, the current route R1, the acquired vehicle environment and/or the acquired vehicle state and for determining an alternative route R2 from position P to destination Z as a function of the probability value W and this position P, and output it with the output means.

2. The device according to claim 1,
wherein the means for determining is configured to determine a driving time to destination Z, a driving distance to destination Z and/or a required fuel consumption for the alternative route R2 in relation to using the current route R1, and output the driving time to destination Z, the driving distance to destination Z and/or the required fuel consumption for the alternative route R2 in relation to using the current route R1 with the output means.

3. The device according to claim 1,
wherein the approaching position P is a turnoff, which when taken must result in a departure from the current route R1, and which lies a distance ranging from 10 m to 1000 m or 50 m to 500 m or 50 m to 300 m ahead of the current position PF of the vehicle on the current route R1.

4. The device according to claim 1,
further comprising a means for determining the approaching position P, which can be linked with a navigation database.

5. The device according to claim 1,
wherein the sensor for acquiring the vehicle environment is an optical sensor or radar sensor or an ultrasonic sensor or LIDAR sensor.

6. The device according to claim 1,
wherein the sensor for acquiring the vehicle state is a position sensor or speed sensor or acceleration sensor or gas pedal position sensor or brake pedal position sensor or turn signal sensor or steering angle sensor.

7. The device according to claim 1,
further comprising a warning device, which outputs a warning depending on the ascertained probability value W for departure from the current route R1 and distance between the current vehicle position PF and the approaching position P.

8. The device according to claim 7,
wherein the warning device outputs different warnings depending on the distance between the current vehicle position and the approaching position P.

9. The device according to claim 1,
wherein the means for determining determines the alternative route R2 according to set criteria as the shortest, fastest or most economical route.

10. A vehicle with a device comprising:
a system for route guidance in a road network along a current route R1 from a current position PF of the vehicle to a destination Z;
a sensor for acquiring a vehicle environment and/or a sensor for acquiring a vehicle state;
an output means, and
a means for determining a probability value W for departure from the current route R1 at an approaching position P of the current route R1 based on the current position PF of the vehicle, the current route R1, the acquired vehicle environment and/or the acquired vehicle state and for determining an alternative route R2 from position P to destination Z as a function of the probability value W and this position P, and output it with the output means.

11. A method for supporting a driver of a vehicle with a system for route guidance in a road network along a current route R1 from a current position PF of the vehicle to a destination Z, a sensor for acquiring a vehicle environment and/or a sensor for acquiring the vehicle state, and an output means, the method comprising the steps of:
acquiring the current position PF of the vehicle, the current route R1 of the vehicle, the vehicle environment and/or the vehicle state;
determining a probability value W for departure from the current route R1 at an approaching position P of the current route R1 based on the current position PF of the vehicle, the acquired current route R1, and the acquired vehicle environment and/or the acquired vehicle state;
determining an alternative route R2 from position P to destination Z as a function of the probability value W, and
outputting the alternative routes R2 with the output means.

12. The method according to claim 11,
wherein a travel time to destination Z, a travel route to the destination Z and/or a fuel consumption in relation to using the current route R1 is determined and output for the alternative route R2.

13. The method according to claim 11,
wherein the approaching position P is a turnoff which, if taken, inevitably leads to the departure from the current route R1, and lies at a distance ranging from 10 m to 1000 m, 50 m to 500 m, or 50 m to 300 m on the current route R1 ahead of the current position PF of the vehicle.

14. The vehicle of claim 10, wherein the vehicle is a motor vehicle.

15. The vehicle according to claim 10, wherein the means for determining is configured to determine a driving time to destination Z, a driving distance to destination Z and/or a required fuel consumption for the alternative route R2 in relation to using the current route R1, and output the driving time to destination Z, the driving distance to destination Z and/or the required fuel consumption for the alternative route R2 in relation to using the current route R1 with the output means.

16. The vehicle according to claim 10, wherein the approaching position P is a turnoff, which when taken must result in a departure from the current route R1, and which lies a distance ranging from 10 m to 1000 m or 50 m to 500 m or 50 m to 300 m ahead of the current position PF of the vehicle on the current route R1.

17. The vehicle according to claim 10, further comprising a means for determining the approaching position P, which can be linked with a navigation database.

18. The vehicle according to claim 10, wherein the sensor for acquiring the vehicle environment is an optical sensor or radar sensor or an ultrasonic sensor or LIDAR sensor.

19. The vehicle according to claim 10, wherein the sensor for acquiring the vehicle state is a position sensor or speed sensor or acceleration sensor or gas pedal position sensor or brake pedal position sensor or turn signal sensor or steering angle sensor.

20. The vehicle according to claim 10, further comprising a warning device, which outputs a warning depending on the ascertained probability value W for departure from the current route R1 and distance between the current vehicle position PF and the approaching position P.
